(19) United States
(12) Patent Application Publication
(10) Pub. No.: US 2010/0032098 A1
(43) Pub. Date: Feb. 11, 2010

(54) WELDING DEVICE FOR PLASTIC BAGS AND METHOD OF HEATING ITS HEATING STRIPS

(76) Inventors: Franck Lalli, Pertuis (FR); Gerard Negrier, Corbieres (FR)

Correspondence Address: Nixon Peabody LLP, P.O. Box 60610, Palo Alto, CA, 94306, US

(21) Appl. No.: 12/441,369

(22) PCT Filed: Sep. 14, 2007
(86) PCT No.: PCT/EP2007/059726

§ 371 Date: Aug. 10, 2009

(30) Foreign Application Priority Data
Sep. 18, 2006 (FR) 06 53794

(51) Int. Cl. B29C 65/24; B23K 11/24

(52) U.S. Cl. 156/359; 219/108

(57) ABSTRACT

The system allows plastic bags to be very securely sealed by welding, using a compact apparatus.

The device uses the multiplexing of the electrical energy sent into the heating strips of the welding tongs. Specifically, the strips are heated by successive waves following one after another in an offset and alternating manner, so that, at each instant, only one heating strip is supplied with power. Thus, the overall energy sent into the heating strips is relatively constant and of low level.

Application to welding tongs for welding plastic bags used for handling contaminated materials in gloveboxes.

### FIELD OF THE INVENTION

The invention concerns the field of welding plastic bags, such as those used for the confinement of contaminated objects and materials and which have to be enclosed in a glovebox, from which they are then extracted.

In particular, it concerns the manner of supplying the heating strips of welding tongs with electricity.

The principal application of the device and the method according to the invention concerns the nuclear industry and more specifically the handling of toxic materials in gloveboxes.

### PRIOR ART AND PROBLEM POSED

Within the context of certain of its industrial activities relating to reprocessing or dismantling, the nuclear industry needs to extract various types of matter and materials placed in gloveboxes. The actual extraction takes place by means of plastic bags that are functionally coupled to a glovebox. The matter to be extracted is thus passed through from the glovebox to the plastic bag, which is placed beforehand in the glovebox. The necessary welds are then carried out on the plastic bag, in order to completely seal it.

In certain cases, the nature and the toxicity of the materials and products handled impose a high quality in the welding of the plastic bags in which they are enclosed, with the aim of guaranteeing the safety of the agents and operators who carry out these operations and the non propagation of the toxic radioactive elements transferred.

At the time of the filing of this patent application, technologies for implementing this type of welding of plastic bags dominate the welding equipment market: the high frequency generator and the assembly based on heating resistors. These two technologies have drawbacks that, for the most part, have been known for a very long time and are linked to the technology employed.

For example, as regards the high frequency generator, the present equipment has very considerable volumes. Reduced manageability ensues from this. Another major failing of this equipment resides in the danger that is linked to their use, because this technology implements power levels of several kilowatts, with electrical voltages between 3 and 5 kilovolts and with currents close to 1 ampere, which introduces risks of burns that cannot be ignored, numerous instances of burns having already led to work stoppages. Furthermore, these high frequency generators are equipped with power triodes, which are components stemming from very old technology and the supply of which remains difficult and relatively costly. Finally, such equipment is bulky and difficult to employ in places where access is limited.

A second type of heating resistance generator is markedly less sophisticated. Specifically, these assemblies associate an electrical generator with a heating resistor which is in the form of a resistive metal strip. They are markedly less dangerous than the high frequency generator and remain nevertheless bulky. Furthermore, the welds produced by this type of apparatus are difficult to reproduce and necessitate numerous adjustments, which make their use very awkward. As regards the tongs associated with these different types of generators, they are not very easy to handle, because they are relatively heavy. Moreover, they are not very easy to open on account of the presence of a spring, which is necessary to maintain the tongs held tight on the material to be welded.

The aim of the invention is thus to overcome said drawbacks by proposing another system for welding plastic bags by heating resistors.

### SUMMARY OF THE INVENTION

To that end, a first principal object of the invention is a method of heating heating strips for welding tongs, each heating strip being supplied with electrical power individually.

According to the invention, it is proposed to send into each heating strip successive waves of electrical energy and spaced in a determined manner and offset from one strip in relation to the other.

In the principal embodiment, when a determined number N of heating strips is used, the distribution of energy is of multiplexed type, the waves each having a duration of 1/N for each heating cycle, each wave being offset in relation to the others by a value of 1/N, in such a way that the electrical power sent overall is constant and multiplexed on the N heating strips.

It is envisaged to be able to width modulate the waves sent to the heating strips.

It is also envisaged to measure the temperature of the heating strips.

A second principal object of the invention is a welding device for welding the opening of plastic bags with the aim of hermetically sealing them, said device comprising:

a tong, itself comprising:

a body,

a first grip jaw that has first control means and prolongs the body; and

a second grip jaw;

several heating strips being installed longitudinally on at least one of the two grip jaws; and

an electrical control and supply device connected to the tongs by a power cord to supply each of the heating strips with power.

According to the invention, the power supply device has means of multiplexing the electrical energy sent to each heating strip, namely a three mode controller of the PID type, to send into these heating strips successive waves of electrical energy and offset over time from one heating strip in relation to another, and the control and supply means comprise means of width modulating wave pulses.

It is also provided to use controlled motorisation means of the upper grip jaw moveably mounted in relation to the other jaw of the tongs.

In this case, it is advantageous to use as tightening means an electric motor driving a screw/nut motor, the nut being connected to the upper jaw of the tongs.

Means of limiting the tightening torque may also complete the assembly.

A thermocouple may also be placed below each heating strip to measure the temperature.

Finally, the first control means assembled on the tongs are limited so that the operator does not have to make detailed adjustments.

### LIST OF FIGURES

The invention and its different technical characteristics will be more fully described on reading the following description, along with four figures respectively representing:

FIG. 1, in partially exploded isometric view, the device according to the invention;

FIG. 2, a diagram showing the position of the thermocouples in relation to the heating strips;

FIG. 3, three graphs relating to the heating cycles of three heating strips;

FIG. 4, a diagram relating to the heating of a heating strip.

### DETAILED DESCRIPTION OF AN EMBODIMENT OF THE INVENTION

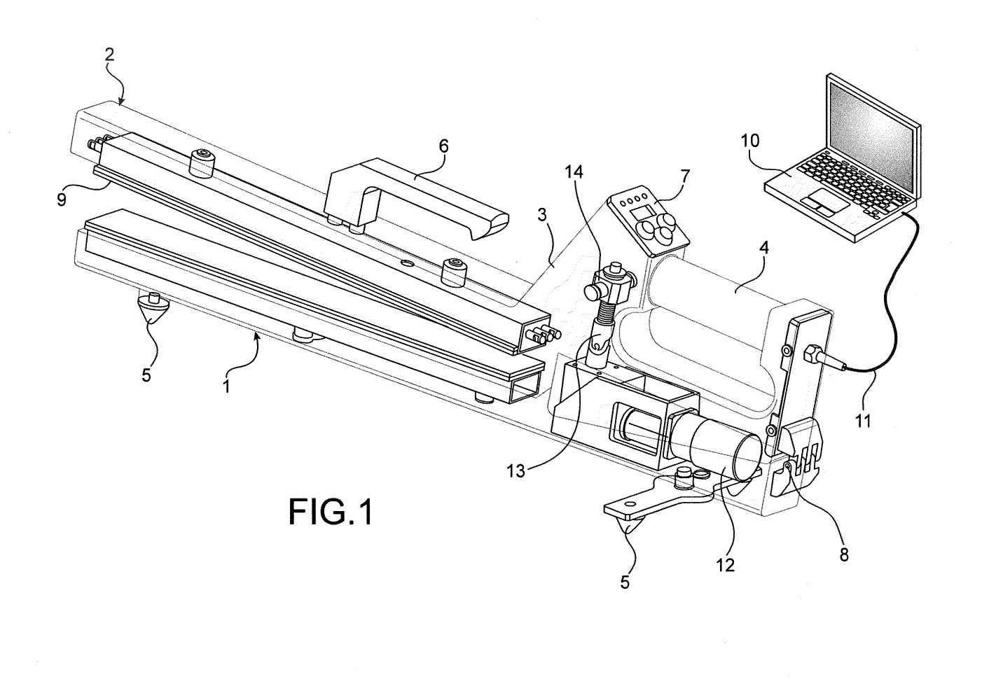

FIG. 1 shows a preferential embodiment of the device according to the invention. The principal parts of the tongs are a lower jaw 1, an upper jaw 2, a casing 3 fixed onto the upper jaw 2. This assembly is completed by an articulation 8 enabling the upper jaw 2 to pivot in relation to the lower jaw 1. It should be noted that the upper jaw 2 may be mounted pivoting in relation to the lower jaw 1 by means of silentblocs that can withstand the crushing and enabling the bag to be held tight during the welding operation.

The lower jaw 1 is equipped with at least three feet 5, one of which is placed towards the distal end of the lower jaw 1. The two others are placed near to the articulation 8.

The upper jaw is equipped with a work handle 6 fixed to said upper jaw. The casing 3 is completed by a grip handle 4 placed near the articulation 8 and has a control panel 7. In this way, the operator can control several welding factors, namely the time, the temperature and the band of heating strips used. By means of a push button, it controls the opening and the closing of the heating cycle.

In this lower jaw 1, on the side of the articulation 8, is placed a motorisation unit 12 making it possible to bring into action a screw 13 of a screw nut system, the nut 14 of which is integral with the upper jaw 2. Thus, an actuation of the motor unit enables the opening and the closing of the upper jaw 2 on the lower jaw 1. The motor unit is mainly constituted of a small electric motor. It may be advantageously completed by a means of limiting the tightening torque.

The tong assembly is obviously completed by an electrical control and supply device 10 connected to the tongs by a power cord 11.

The control and supply device 10 may be provided with two different sources of electrical current, namely a 24 volt alternating current source or a direct current source by battery. This enables the greatest autonomy with the regard to the installation as a whole. It should noted that the tong body 3 is occupied by an electronic control deck assuring the management of the assembly and receiving the various data from the operator, through the intermediary of the control panel 7.

The heating strips intended to perform the welding of the bags by means of the tongs according to the invention are placed on the lower face 9 of the upper jaw 2.

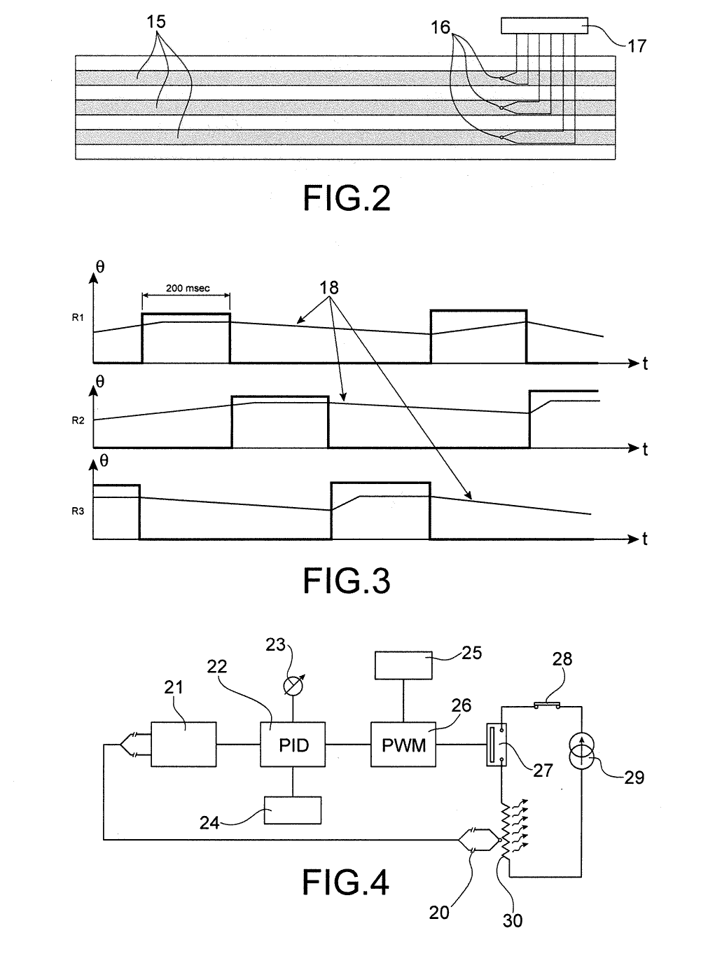

FIG. 2 represents three of its heating strips 15 placed parallel to each other and longitudinally below the lower jaw 2. A heat detector, such as a thermocouple 16, is used for each heating strip 15. In other words, a thermocouple 16 is placed below each of the heating strips 15. Each of them is connected to a data receiver 17 forming part of the control and supply device 10.

The operation of the assembly, the method of heating used and the different aspects of controlling and implementing the method are described in the following paragraphs.

In the embodiment chosen, three heating strips are used.

The principal idea of the invention is not to supply power to the three heating strips 15 at the same time during the welding phase. Specifically, heating them all at the same time would require the use of a massive and bulky generator. It is thus proposed to distribute the electrical energy in a sequential manner, a single heating strip 15 being supplied with power at any one time, for example with a period of 200 milliseconds.

FIG. 3 shows three graphs respectively relating to the three heating strips. The curves drawn in thick lines and in the form of time slots are representative of the electrical energy sent into each heating strip. The curves 18 drawn in medium lines represent the temperature of each heating strip. It will be seen that each heating strip is heated in an offset manner compared to the others. Thus, the electrical energy sent into the system is overall constant. Specifically, when the electrical energy is stopped being sent into the first heating strip, the second starts to be supplied, and so on with the second and the third strips.

Thus, it is possible to control perfectly the energy distributed by the installation as a whole in the heating strips, in order to ensure the quality and the repeatability of the welds thereby generated without having to use a too powerful generator. A multiplexed current generator is used and as means of multiplexing the electrical energy a three mode controller of the PID type, in other words proportional-integral-derivative, is used. A distribution of energy by means of pulse width modulation is used, and means of measuring the temperature below each heating strip in the form of thermocouples. Thus, it is possible to manage as closely as possible the energy distributed in each heating strip, while at the same time using semi-conductors existing on the market. The use of a three mode controller of the PID type assures a regulated temperature at each heating strip.

Since the three welds are made in a single operation, each heating strip, which is constituted of a resistor, must be heated to a given temperature to attain the melting temperature of the plastic constituting the bag to be sealed. Specifically, as is shown by the curves 18, between each heating phase, the heating strip cools down slightly, but not sufficiently to hamper the welding process. If it is wished to minimise the amplitudes of temperature near to the resistors constituting the heating strip during the welding phases, it is necessary to work with time constants less than a second. For example, 200 ms is chosen for the activation phase of each heating strip, which gives a rest phase of 400 ms during which the heating strips are no longer supplied with power.

Consequently, the time of a cycle is in this case 600 ms. The three mode controller is guided by an INTEL microcontroller of the 8051 type. The assembly is associated with the temperature measurement system, which can use in this case a thermocouple of the K type, the range of use of which corresponds to the envisaged application. In the present application, the derivative action is reset to zero because it is not used.

An anti-saturation device is implemented on the algorithm of the PID type three mode controller. Three separate devices of this type are thus available with, for each of them, its own adjustment parameters, as well as its own time context.

Thermocouple preamplifiers of MAX 6675 type are associated with the microcontroller, have an internal cold weld compensation system and are interrogated by digital means with a protocol of the NISO/MOSI type specific to this integrated circuit.

Concerning the thermocouples used below the heating strips, it is provided to choose them of low diameter, in order to minimise the time constants and to place them as near as possible to the heating zones, without however coming into contact with them, in order that the measurement taken is as close as possible to reality.

A digital transmission bus, of 12C type, has been implemented in the control and supply device, in order to communicate with an EEPROM type memory, with series access, which serves as storage zone for the functional parameters of the welding tong.

FIG. 4 shows a control assembly of a heating strip. The temperature measurement is thus carried out by a thermocouple 20 on the heating strip 30. It is transmitted to the PID type three mode controller, through the intermediary of a temperature transmitter 21. It is compared to predetermined set temperatures 23 and to other parameters 24. A signal from the PID three mode controller 22 is sent to a generator 26 of the PWM type which generates, by means of a time base 25, pulses of variable width, which are going to supply the heating strips 30 through the intermediary of power switching means 27, such as alternating current static relays. The operator can intervene by means of a switch 28, the assembly being supplied with electrical power by a generator or a battery 29. The pulse width modulator makes it possible to vary, according to the calculation from the PID three mode controller 22, the value of the activation time for each resistor each constituting a heating strip 30.

It should be noted, in the envisaged embodiment, that it is provided that the operator only has five cycle times programmed in advance so as to simplify the operations for him, while at the same time enable him to adapt to different situations. Nevertheless, the control and supply device has many possibilities of adjusting numerous other parameters, such as the predetermined set temperature, the coefficients relative to the PID three mode controller, enabling it to adapt to various types of materials to be welded. The parameters are memorised in the tongs and a connection to the control and supply device makes it possible to visualise and modify said parameters, in order to adapt to different welding configurations.

Thus, a certain modulability enables the equipment as a whole to be used easily.

The quality of the tightening of the tongs has a considerable influence on the quality of the weld to be carried out and makes it possible to assure a certain reproducibility over time. Moreover, in order to assure the proper control of the tightening torque, a measurement of the supply current of the motor is carried out, the voltage being applied to an analogue-digital converter of the LT 1298 type of LINEAR TECHNOLOGY. Thus, the microcontroller has, during the tightening, the information relative to the torque of the motor, directly translated digitally, through the intermediary of a converter of the analogue-digital converter type. The integration of the image of the tightening torque is thus carried out and the electrical supply of the motor is cut as soon as a threshold value is attained. The motorisation of the tightening of the tongs thus procures an ease of use.

Regarding the power source marked 29 in FIG. 4, the normal electrical energy source is obviously alternating current, such as provided by the mains at the voltage of 220 volts. In the case of voltage adaptation to supply welding tongs, such as that shown, a transformer-step down transformer having a power of several hundreds of volts-amperes that supplies the voltage of 24 volts is used.

To make it possible to perform welds in places of difficult access where mains power supply is not possible, the assembly is provided with a direct current battery to assure the electrical power supply. The first advantage of such a device is its autonomy. The other advantage is to be able to choose the storage cell as a function of the number of welds to be carried out.

It should be noted that the heating strips are maintained taut and connected by a connector, housed inside the tong body 3 and inaccessible to the user.

A tong-control and supply device assembly is formed that does not exceed the weight of 4 kg.

A more detailed description will now be made of the operation of the whole of the device and which is carried out by means of programmes installed within the microcontroller.

The heart of the control and supply means is constituted of a clock timed to a period of two milliseconds and which serves as time base to the whole assembly.

The welding request is made by means of the push button of the control panel 7, coupled with a minimum pressing time of several seconds. The interrogation of the state of the push button is permanent. The programme for managing the tongs has a memorised and predetermined set point, given that the user has five programmed cycle times.

During the phases of rest or non use of the tongs, the running of the programme is identical to that of a sequence of heating to near the set value. This set value is zero during the period of inactivity of the tongs. On the other hand, if a welding request is made, the EEPROM memory provides the value of the set point and this then becomes effective. The heating of heating strips starts until the predetermined set temperature is reached. The three mode controller of the PID type ensures that the temperature on each heating strip is stable and complies with the set point.

Once the cycle has ended, a cooling cycle begins, which is signalled to the user and necessary so that the weld does not tear on opening the tongs. At the end of the cooling period, the system returns to its initial state with the set point reset to zero.

The information relative to the functional state of the tongs is available on an asynchronous serial connection of RS 232 type. Among said information is found, among others, the temperatures of the three heating strips, as well as the possibility of modifying all of the parameters. This connection makes it possible to control the tongs, which may be used to fine tune the adjustment parameters and may prove to be very useful for the maintenance of the assembly.

### ADVANTAGES OF THE INVENTION

The material is easily made safe for the user.

The conception is simple.

The weight is reduced and the manageability is thereby enhanced.

A high reliability of the welds to be carried out is obtained.

It is possible to perform welds in areas that are difficult to access and/or are lacking an electricity supply.

1. Welding device to weld the opening of plastic bags in order to seal them hermetically and comprising:
a tong itself comprising:
a tong body;
a lower jaw; and an upper jaw moveably mounted in relation to the lower jaw,
several heating strips being installed longitudinally on one of the two jaws, the tong body being integral with the upper jaw; and
a control and supply device connected to the tongs by a power cord to supply each of the heating strips with power, characterised in that the control and supply device has means of multiplexing the electrical energy sent into each of the heating strips, constituted in particular of a three mode controller of PID type, to send into said heating strips successive energy waves and offset over time from one heating strip in relation to another, in such a way that, at each instant, the electrical power is only sent to a single heating strip,
and in that the control and supply device comprises means of modulating the pulse width.

2. Welding device according to claim 1, characterised in that a thermocouple is used for each heating strip to carry out a temperature control.

3. Welding device according to claim 1, characterised in that it comprises controlled motorisation means of the upper jaw in relation to the lower jaw.

4. Welding device according to claim 3, characterised in that the controlled motorisation means comprise:
an electric motor driving a screw-nut system, the nut being connected to the upper jaw; and
means of limiting the tightening torque applied to the jaws.

5. Device according to claim 1, characterised in that the control and supply device has an alternating current source.

6. Device according to claim 1, characterised in that the control and supply device has a direct current source by battery.

7. Method of heating a welding tong heating strip, each heating strip being supplied with power individually, characterised in that it consists in sending into each heating strip the successive waves of electrical energy and spaced in a determined manner and offset from one strip in relation to another, so that, at each instant, a single heating strip is supplied with power.

8. Method according to claim 7, to heat a determined number N of heating strips, characterised in that the waves have a duration of 1/N, each wave being offset in relation to the others by a value of 1/N, so that the power sent overall into the assembly is constant, in other words that the energy is multiplexed.

9. Method of heating according to claim 8, characterised in that a modulation of the width of the waves is carried out.

10. Method of heating according to claim 7, characterised in that a measurement of the temperature of the heating strips is carried out.
